(19) United States
(12) Patent Application Publication
(10) Pub. No.: US 2006/0022377 A1
(43) Pub. Date: Feb. 2, 2006

(54) Longitudinal programming for extruded hollow plastic profile sheets

(75) Inventors: Pat O'Connell, Hershey, PA (US); Rob Schnabel, Loganville, PA (US)

Correspondence Address: VENABLE LLP, P.O. BOX 34385, WASHINGTON, DC, 20045-9998, US

(73) Assignee: GRAHAM PACKAGING COMPANY, L.P., York, PA (US)

(21) Appl. No.: 10/901,098

(22) Filed: Jul. 29, 2004

(51) Int. Cl. B29C 47/00; B29C 47/22

(52) U.S. Cl. 264/167; 264/209.8; 425/381

(57) ABSTRACT

An apparatus for varying the thickness of an extruded material includes a hollow die body having an extruding direction and an extruding end with an opening, and a moveable plug arranged inside of the hollow die body. The moveable plug moves in the extruding direction within the opening. When material is extruded through the hollow die body in the extruding direction, the plug forms a void in the extruded material. The position of the moveable plug in the opening determines a thickness of the extruded material surrounding the void.

### BACKGROUND OF THE INVENTION

1. Field of the Invention

The present invention relates generally to extruded materials, and more particularly to extruding hollow plastic profile sheets.

2. Related Art

Plastic sheets used, for example, in constructing packaging materials, can be formed by extruding molten plastic through a die to form a sheet. In order to decrease the weight of the plastic where strength is not needed, the die can be modified to introduce voids within the plastic sheet, creating a hollow plastic profile sheet.

Conventionally, the size of the voids created can be varied along the width of the extruded sheet. The thickness of any part of the extruded sheet, however, remains constant over the length of the sheet in the extrusion direction. If different thicknesses are needed from those of a specified die arrangement along the length of the extruded sheet, the dies must be changed out, or adjusted, and a new sheet must be extruded. Therefore, the thickness of an extruded sheet cannot be varied cyclically along its length.

What is needed then is an improved method and apparatus that overcomes shortcomings of conventional solutions.

### BRIEF SUMMARY OF THE INVENTION

In summary, an embodiment of the present invention provides a method and apparatus to vary the size of an individual void along the length of an extruded plastic sheet while the sheet is being extruded.

In an exemplary embodiment, the present invention may be a method of varying the thickness of an extruded material, including: arranging a moveable plug inside of a hollow die body, where the hollow die body has an extruding direction and an extruding end with an opening, and where the moveable plug moves in the extruding direction within the opening; extruding the material through the hollow die body in the extruding direction, where the plug forms a void in the extruded material; and varying a position of the plug in the opening, where the position determines a thickness of the extruded material surrounding the void.

In another exemplary embodiment, the present invention may be an apparatus for varying the thickness of an extruded material, including: a hollow die body having an extruding direction and an extruding end with an opening; and a moveable plug arranged inside of the hollow die body. The moveable plug moves in the extruding direction within the opening. When material is extruded through the hollow die body in the extruding direction, the plug forms a void in the extruded material. The position of the moveable plug in the opening determines a thickness of the extruded material surrounding the void.

In another exemplary embodiment, the present invention may be a method of varying the thickness of an extruded material, comprising: extruding a material through a hollow die gap in an extruding direction at an extruding speed onto a moving surface, where the moving surface moves in the extruding direction at a line speed; and varying the extruding speed with respect to the line speed, where the variation causes differences in a thickness of the extruded material along the extruding direction.

In another exemplary embodiment, the present invention may be a method of varying the thickness of an extruded material, comprising: extruding a material through an opening in an adjustable hollow die gap in an extruding direction at an extruding speed; and varying a size of the opening during the extruding, wherein the variation causes differences in a thickness of the extruded material along the extruding direction.

Further objectives and advantages, as well as the structure and function of preferred embodiments will become apparent from a consideration of the description, drawings, and examples.

### BRIEF DESCRIPTION OF THE DRAWINGS

The foregoing and other features and advantages of the invention will be apparent from the following, more particular description of a preferred embodiment of the invention, as illustrated in the accompanying drawings wherein like reference numbers generally indicate identical, functionally similar, and/or structurally similar elements.

FIG. 1 depicts a cross-section of an exemplary embodiment of a die body according to the present invention;

FIG. 2 depicts a cross-section an exemplary embodiment of a moveable plug according to the present invention;

FIG. 3 depicts an exemplary embodiment of a cross-section of extruded material according to the present invention;

FIG. 4A depicts a cross-section of an exemplary embodiment of the extruded material shown in FIG. 3 according to the present invention; and

FIG. 4B depicts a different cross-section of an exemplary embodiment of the extruded material shown in FIG. 3 according to the present invention.

### DETAILED DESCRIPTION OF THE INVENTION

Embodiments of the invention are discussed in detail below. In describing embodiments, specific terminology is employed for the sake of clarity. However, the invention is not intended to be limited to the specific terminology so selected. While specific exemplary embodiments are discussed, it should be understood that this is done for illustration purposes only. A person skilled in the relevant art will recognize that other components and configurations can be used without parting from the spirit and scope of the invention. All references cited herein are incorporated by reference as if each had been individually incorporated.

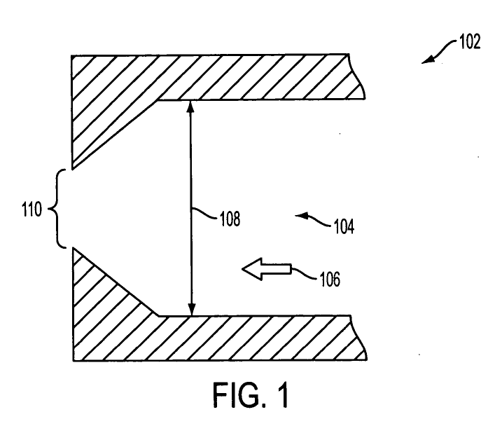

As seen in the cross-section in FIG. 1, an embodiment of the present invention may include a die body 102. The die body is a hollow tube 104 through which the material to be extruded flows. The extruded material flows in an extruding direction as indicated by arrow 106. The tube 104 may be cylindrical, triangular, rectangular or any other shape. The tube 104 has an inner diameter 108. As used herein, “diameter” refers generally to the distance from one inner side of the tube to an opposite inner side of the tube, regardless of the tube's cross-sectional shape.

At the front end of the tube 104 where the material exits the tube, the tube has an extruding end with an opening 110 that has a diameter narrower than the inner diameter of the tube. The size of the opening 110 increases gradually toward the inside of the tube 104 until the size of the extruding opening 110 matches the inner diameter 108.

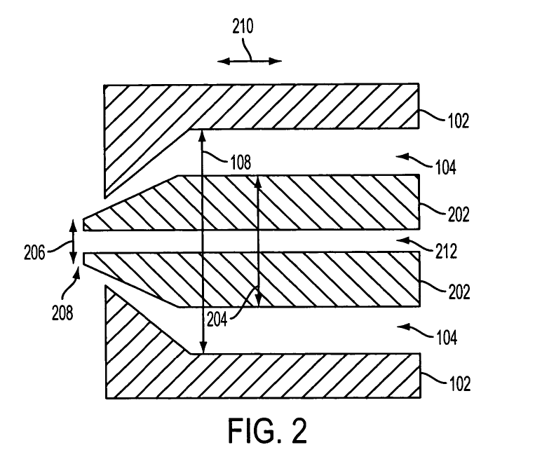

As seen in the cross-section in FIG. 2, a moveable plug 202 is placed inside of the die body 102. The movable plug 202 is also a tube with a smaller total diameter 204 than the inner diameter 108 of the die body 102. The moveable plug 202 may be essentially coaxial to the die body tube 104. The total diameter 204 tapers to a smaller diameter 206 at a tapered end 208. The total diameter 204 may be larger than the front end opening 110 of the die body 102. The smaller diameter 206 of the tapered end 208 may be smaller than the front end opening 110 of the die body 102. The moveable plug 202 may be moved back and forth in the direction indicated by arrow 210, causing the tapered end 208 to move within the front end opening 110.

In an exemplary embodiment, the angle formed by the increasing diameter of the opening 110 may be different from the angle formed by the tapered end 208. For example, the angle formed between the opening and the inner diameter could be 28 degrees, while the angle formed by the taper could be 20 degrees.

The material to be extruded flows between the outside of the moveable plug 202 and the inside of the die body tube 104, where the material is extruded from the opening 110. The position of the moveable plug 202, and of the tapered end 208, with respect to the opening 110 determines the size of the opening through which the material is extruded. For example, when the plug is retracted into the die body tube, the opening is large and more material is extruded. When the plug is extended, the opening is small, and less material is extruded.

In an exemplary embodiment, the center 212 of the moveable plug tube is hollow. Air may be blown through the hollow space 212 to support the void formed in the extruded material.

In an exemplary embodiment the plug may be moved back and forth with respect to the front end opening while the material is being extruded. Thus, the amount of the extruded material can be varied throughout its length as needed. The movement of each plug may be controlled independently, or plugs may be grouped together and controlled as a group.

The positions of the plugs in the die bodies may be controlled by a computer. For example, the dimensions and profile of the sheet to be produced may be used by a software application to control the movement of the plugs via a mechanical device coupled to the plugs. Regardless of the source of control, variation of the dimensions and profile of a sheet may be repeated such that subsequent cutting of the sheet can produce a plurality of similar products.

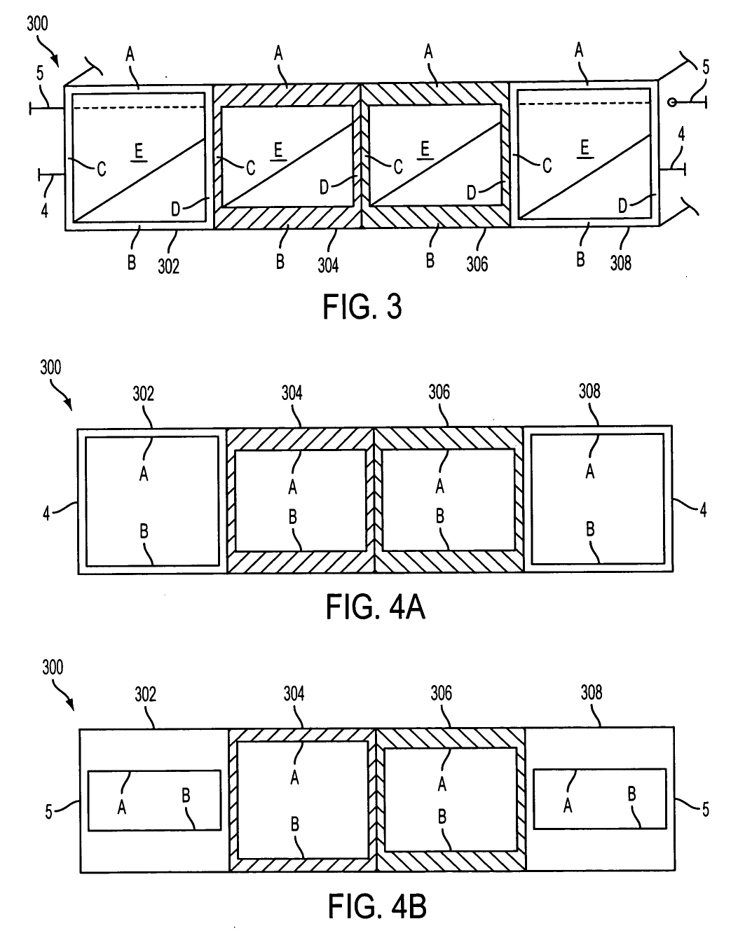

FIG. 3 shows a perspective view cross section of an exemplary plastic sheet 300 extruded using an embodiment of the present invention. The sheet 300 has four conjoined cells 302, 304, 306, and 308 along the width of the sheet 300. Each cell has a top wall A, a bottom wall B, a left wall C and a right wall D that collectively contain a void E. Although the embodiment shown has four cells, in practice, any number of cells may be formed in the sheet 300. Similarly, although the shape shown of void E is generally rectangular, the shape of void E could be any shape, according to the shape of moveable plug 202.

FIG. 4A shows a cross-section of sheet 300 along line 4-4 of FIG. 3. Generally, cells 304 and 306 have thicker top and bottom walls A and B than cells 302 and 308.

At some time in the extrusion process between the extrusion of sheet 300 along line 4-4 and line 5-5, the moveable plugs that formed each cell were moved. FIG. 4B shows the new cross-section of sheet 300 along line 5-5 of FIG. 3. As compared to FIG. 4A, cell 302 has thicker top and bottom walls A and B. As compared to FIG. 4A, cell 304 has thinner top and bottom walls A and B. As compared to FIG. 4A, cell 306 is unchanged, while cell 308 has thicker top and bottom walls A and B. Thus, the thickness of the walls of each cell can be varied along the length of a single extruded sheet.

In the embodiments shown, the thickness of the top and bottom of the extruded sheets is varied. However, it is also possible to vary the thickness of the material between the voids, for example, by using a different orientation of the illustrated die and plug combination, or by using a different shaped die and plug combination.

In another exemplary embodiment, the thickness of the extruded sheet can be varied along the length of the sheet during extrusion without the use of the moveable plug 202. In this embodiment, conventional die assemblies may be used. Variations in the speed of the line in coordination with the speed of extrusion may result in changes in the thickness of the extruded material along the length of the extruded material. Alternatively, varying the size of the die extrusion opening in coordination with the longitudinal position of the sheet during extrusion may also result in changes in the thickness along the length of the extruded material. In either case, the thickness of the extruded material may be varied cyclically to produce identical sections of extruded material, with the same variations in thickness per section.

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

What is claimed is:

1. A method of varying the thickness of an extruded material, comprising:
a) arranging a moveable plug inside of a hollow die body, wherein said hollow die body has an extruding direction and an extruding end with an opening, and wherein said moveable plug moves in the extruding direction within said opening;
b) extruding the material through said hollow die body in the extruding direction, wherein said plug forms a void in the extruded material; and
c) varying a position of said plug in said opening, wherein said position determines a thickness of said extruded material surrounding said void.

2. The method of claim 1, wherein (a) comprises arranging said moveable plug inside of and coaxial to said hollow die body.

3. The method of claim 1, further comprising:
arranging a plurality of moveable plugs in a plurality of hollow die bodies along a width of the extruded material; and
varying the position of at least one plug independently of the position of another of the plugs.

4. The method of claim 1, further comprising:
arranging a first grouping of moveable plugs and a second grouping of moveable plugs in a plurality of hollow die bodies along a width of the material to be extruded; and
varying the position of said first grouping of plugs independently of the position of said second grouping of plugs.

5. The method of claim 1, wherein (c) comprises varying said position of said moveable plug in the extruding direction.

6. An apparatus for varying the thickness of an extruded material, comprising:
a hollow die body having an extruding direction and an extruding end with an opening; and
a moveable plug arranged inside of said hollow die body, wherein said moveable plug moves in the extruding direction within said opening;
wherein when material is extruded through said hollow die body in the extruding direction, said plug forms a void in the extruded material; and
wherein a position of said moveable plug in said opening determines a thickness of said extruded material surrounding said void.

7. The apparatus of claim 6, wherein said hollow die body comprises a tube having a front end opening, wherein said front end opening is narrower than an inner diameter of said tube and wherein inner diameter tapers to said front end opening within said tube.

8. The apparatus of claim 7, wherein said moveable plug comprises:
a hollow tube formed from a sidewall and having an outer diameter; and
a tapered end wherein said outer diameter tapers to a narrower second end diameter at said tapered end, and wherein said tapered end is moveable within said front end opening and operative to change a thickness of the material being extruded between said sidewall and said inner diameter.

9. The apparatus of claim 8, further comprising:
means for controlling said movement of said plug within said front end opening.

10. The apparatus of claim 8, wherein a fluid flows through said hollow tube of said moveable plug to support said void.

11. The apparatus of claim 10, wherein said fluid is air.

12. The apparatus of claim 6, wherein said moveable plug is arranged inside of and coaxial to said hollow die body.

13. The apparatus of claim 9, further comprising
a plurality of moveable plugs in a plurality of hollow die bodies along a width of the extruded material, wherein said means for controlling varies the position of at least one plug independently of the position of another of the plugs.

14. The apparatus of claim 9, further comprising:
a first grouping of moveable plugs in a plurality of hollow die bodies along a width of the material to be extruded; and
a second grouping of moveable plugs in a plurality of hollow die bodies along a width of the material to be extruded;
wherein said means for controlling varies the position of said first grouping of plugs independently of the position of said second grouping of plugs.

15. The apparatus of claim 9, wherein said means for controlling varies said position of said moveable plug in the extruding direction.

16. A method of varying the thickness of an extruded material, comprising:
extruding a material through a hollow die gap in an extruding direction at an extruding speed onto a moving surface, wherein said moving surface moves in said extruding direction at a line speed; and
varying said extruding speed with respect to said line speed, wherein said variation causes differences in a thickness of said extruded material along said extruding direction.

17. The method of claim 16, wherein said varying said extruding speed is performed cyclically.

18. A method of varying the thickness of an extruded material, comprising:
extruding a material through an opening in an adjustable hollow die gap in an extruding direction at an extruding speed; and
varying a size of said opening during said extruding, wherein said variation causes differences in a thickness of said extruded material along said extruding direction.

19. The method of claim 18, wherein said varying said size of said opening is performed cyclically.
